(19) United States
(12) Patent Application Publication
(10) Pub. No.: US 2008/0140972 A1
(43) Pub. Date: Jun. 12, 2008

(54) Memory card system with password confirmation and transmission

(76) Inventor: Gwang-myung Kim, Suwon-si (KR)

Correspondence Address: LAW OFFICE OF MONICA H CHOI, P O BOX 3424, DUBLIN, OH, 430160204, US

(21) Appl. No.: 11/983,123

(22) Filed: Nov. 7, 2007

(30) Foreign Application Priority Data
Nov. 16, 2006 (KR) 2006-113430

(51) Int. Cl. G06F 12/14

(52) U.S. Cl. 711/164; 711/E12.094

(57) ABSTRACT

A memory card system includes a memory card and a host for generating a password confirm command and a password transmission command. The password confirm command is used for determining whether a password has been set in the memory card. Each of the password confirm command and the password transmission command may be sent via at least one of a command line or a data line between the host and the memory card.

This application claims priority under 35 USC § 119 to Korean Patent Application No. 2006-113430, filed on Nov. 16, 2006 in the Korean Intellectual Property Office, the disclosure of which is incorporated herein in its entirety by reference.

### BACKGROUND OF THE INVENTION

1. Field of the Invention

The present invention relates generally to memory card systems, and more particularly, to a memory card system with password confirmation and transmission.

2. Background of the Invention

Recently, use of memory cards is increasing. Examples of memory cards include Secure Digital (SD) cards, Multi-Media Cards (MMCs), extreme Digital (xD) cards, Compact Flash (CF) cards, Smart Media (SM) cards, and memory sticks. Such memory cards are used in a variety of hosts such as hand-held phones, MP3 players, Portable Media Players (PMP), and digital cameras.

FIG. 1 is a block diagram of a typical memory card system 1 as known in the prior art. The typical memory card system 1 includes a host 10 and a memory card 20. The host 10 includes a host controller 11 and a host connection unit 12. The memory card 20 includes a card connection unit 21, a card controller 22, and a memory 23.

Each of the host connection unit 12 and the card connection unit 21 includes a respective plurality of pins, including a respective command pin, a respective data pin, a respective clock pin, and a respective power pin. The number of the pins may be dependent on the type of the memory card 20. For example, an SD memory card has nine pins.

The host 10 writes data on the memory card 20 or reads data from the memory card 20. The host controller 11 transmits a command CMD (e.g., a write or read command), a first clock signal CLK1 generated from a clock generator (not shown) within the host 10, and data DAT through the host connection unit 12 to the memory card 20. For example, in response to the write command CMD received through the card connection unit 21, the card controller 22 stores data in the memory 23 in synchronization with a second clock signal CLK2 generated from a clock generator (not shown) within the card controller 22.

Unfortunately, the typical memory card 20 may be used by a third party without limitation, in addition to its owner. Even though the SD card or the MMC support a lock/unlock function, this function is used only in the host. When the memory card is locked, the read and write operations of the memory card are stopped. The read and write operations of the memory card are resumed when the memory card is unlocked.

However, when the memory card is lost by the owner after being set to the unlocked mode, a third party may read data from the memory card or write new data to the memory card without limitation. Such a memory card is especially disadvantageous when the memory card stores sensitive information such as credit card information.

### SUMMARY OF THE INVENTION

Accordingly, a memory card system according to a present invention includes password confirmation and transmission for protecting data stored in a memory card.

A memory card system according to an aspect of the present invention includes a memory card and a host for generating a password confirm command. The memory card includes a card data processor and a card memory device having first sequences of instructions stored thereon. Execution of the first sequences of instructions causes the card data processor to perform steps of:

generating a password confirm signal indicating whether a password is set in the memory card in response to the password confirm command; and

transmitting the password confirm signal to the host via at least one of a data line and a command line between the host and the memory card.

In another embodiment of the present invention, the host includes a host data processor and a host memory device having second sequences of instructions stored thereon. Execution of the second sequences of instructions causes the host data processor to perform a step of:

generating the password confirm command.

In a further embodiment of the present invention, execution of the second sequences of instructions causes the host data processor to perform a step of:

transmitting the password confirm command from the host to the memory card via the command line.

In another embodiment of the present invention, execution of the second sequences of instructions causes the host data processor to perform steps of:

generating a password in response to the password confirm signal; and

transmitting the password to the memory card via at least one of the data line and the command line.

In a further embodiment of the present invention, execution of the first sequences of instructions causes the card data processor to perform a step of:

performing an operation when the password from the host coincides with a password stored in the memory card.

In another embodiment of the present invention, execution of the first sequences of instructions causes the card data processor to perform a step of:

performing a read or write operation when the password from the host coincides with the password stored in the memory card.

In a further embodiment of the present invention, execution of the second sequences of instructions causes the host data processor to perform steps of:

generating a password setting command in response to the password confirm signal;

generating an encrypted password within the password setting command; and

transmitting the password setting command from the host to the memory card via at least one of the command line and the data line. In that case, execution of the first sequences of instructions causes the card data processor to perform a step of:

setting a password stored in the memory card to the password in the password setting command sent from the host.

In another embodiment of the present invention, execution of the second sequences of instructions causes the host data processor to perform steps of:

generating a password changing command in response to the password confirm signal;

generating an encrypted password within the password changing command; and

transmitting the password changing command from the host to the memory card via at least one of the command line and the data line. In that case, execution of the first sequences of instructions causes the card data processor to perform a step of:

setting a password stored in the memory card to the password in the password changing command sent from the host.

The present invention may be used to particular advantage when the memory card is a secure digital (SD) card or a multi-media card (MMC).

In an alternative embodiment of the present invention, a marking on the memory card indicates to a user whether a password is set in the memory card.

In this manner, the setting of the password within the memory card is first confirmed via one of the command line or the data line before subsequent password transmission and operation.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a typical memory card system, according to the prior art;

FIG. 2 is a plan view of a Secure Digital (SD) memory card, according to an embodiment of the present invention;

FIG. 3 is a table showing names and descriptions of pins of the SD memory card of FIG. 2, according to an embodiment of the present invention;

FIGS. 4a and 4b illustrate a command format and a response format, respectively, for a command and a response transmitted in a memory card system according to an embodiment of the present invention;

FIG. 5a shows a memory card system for password confirmation via a command line according to an embodiment of the present invention;

FIGS. 5b and 5c illustrate password confirm and response formats, respectively, for transmission via the command line in the memory card system of FIG. 5a according to an embodiment of the present invention;

FIG. 6a shows a memory card system for password confirmation via data and command lines according to another embodiment of the present invention;

FIGS. 6b and 6c illustrate password confirm and response formats, respectively, for transmission via the data and command lines in the memory card system of FIG. 6a according to an embodiment of the present invention;

FIG. 7a shows a memory card system for password transmission via a command line according to an embodiment of the present invention;

FIG. 7b illustrates a password transmission format for transmission via the command line in the memory card system of FIG. 7a according to an embodiment of the present invention;

FIG. 8 shows a memory card system for password transmission via a data line according to an embodiment of the present invention;

FIG. 9 shows a block diagram of a host and a memory card in the memory card system of FIG. 5a, 6a, 7a, or 8, according to an embodiment of the present invention; and

FIGS. 10 and 11 show flowcharts during operation of the memory card system of FIG. 5a, 6a, 7a, 8, or 9 according to an embodiment of the present invention.

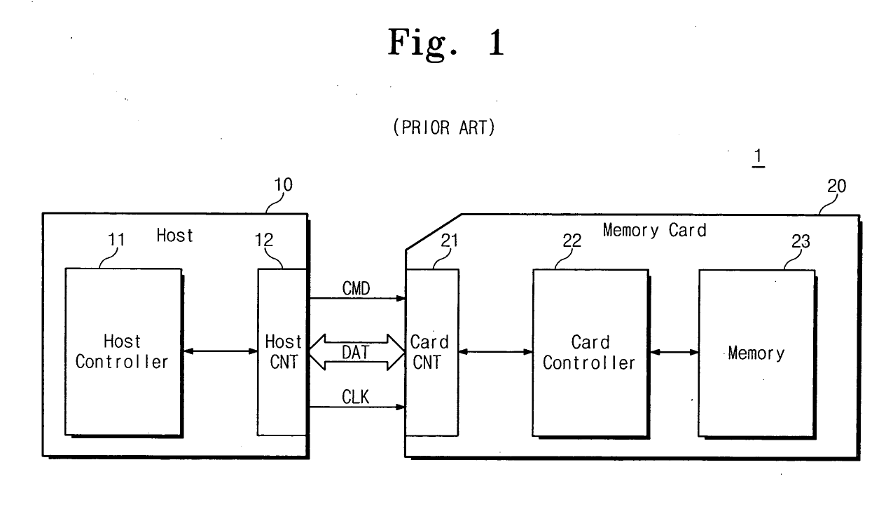

The figures referred to herein are drawn for clarity of illustration and are not necessarily drawn to scale. Elements having the same reference number in FIGS. 1, 2, 3, 4, 5a, 5b, 5c, 6a, 6b, 6c, 7a, 7b, 8, 9, 10, and 11 refer to elements having similar structure and/or function.

### DETAILED DESCRIPTION OF THE INVENTION

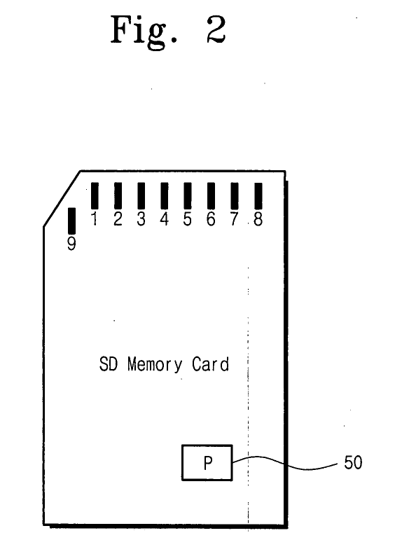

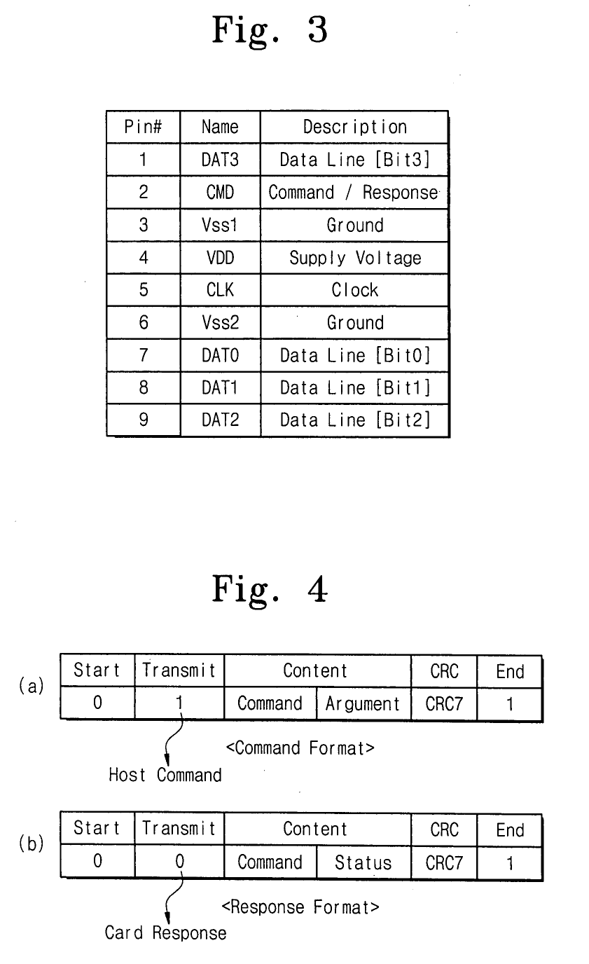

FIG. 2 is a plan view of a Secure Digital (SD) memory card according to an embodiment of the present invention. FIG. 3 is a table showing names and descriptions of pins of the SD memory card of FIG. 2 according to an embodiment of the present invention;

The SD card of FIG. 2 has nine pins with respective pin numbers 1, 2, 3, 4, 5, 6, 7, 8, and 9. More specifically, as illustrated in FIG. 3, the SD card of FIG. 2 has four data pins (with pin numbers 1, 7, 8 and 9), one command pin (with pin number 2), one clock pin (with pin number 5), and three power pins (with pin numbers 3, 4 and 6).

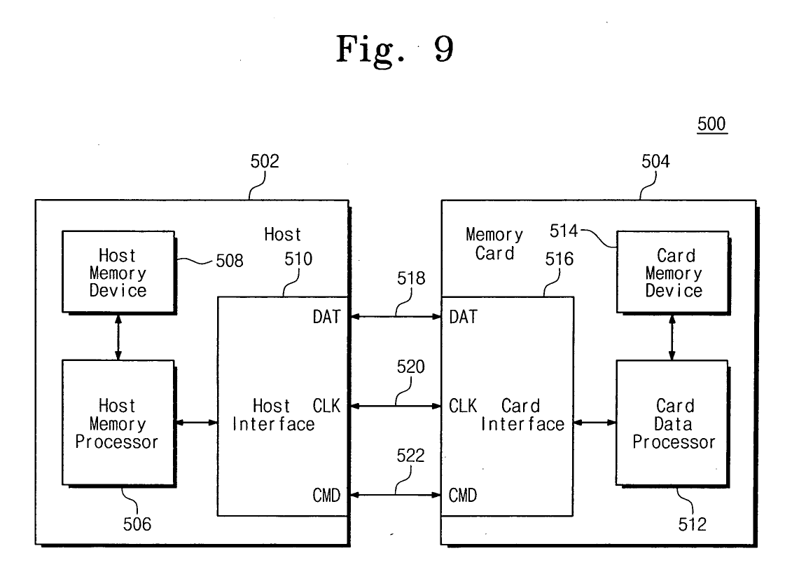

FIG. 9 shows a memory card system 500 according to an embodiment of the present invention. The memory card system 500 includes a host 502 and a memory card 504. The host includes a host data processor 506, a host memory device 508, and a host interface 510. The memory card 504 includes a card data processor 512, a card memory device 514, and a card interface 516.

The memory card 504 may be the SD memory card of FIG. 2. Alternatively, the memory card 504 may be other types of memory cards such a Multi-Media Card (MMC). The host 502 is an electronic device using such as a memory card 504 inserted therein. The card interface 516 makes electrical connection with the host interface 510 when the memory card 504 is inserted into the host 502.

A data line 518 connects a respective data pin of the host interface 510 with a respective data pin (such as pin number 7 in FIG. 2) of the card interface 516. A clock line 520 connects a respective clock pin of the host interface 510 with a respective clock pin (such as pin number 5 of FIG. 2) of the card interface 516. A command line 522 connects a respective command pin of the host interface 510 with a respective command pin (such as pin number 2) of the card interface 516.

Referring to FIGS. 3 and 9, a command from the host 502 and a response from the memory card 504 are transmitted through the command line 522. The command is transmitted via the command line 522 from the host 502 to the memory card 504. The response is transmitted via the command line 522 from the memory card 504 to the host 502.

FIG. 4a shows a format for such a command from the host 502 to the memory card 504. FIG. 4b shows a format for such a response from the memory card 504 to the host 502. Referring to FIG. 4a, the format for the command from the host 502 to the memory card 504 includes a start bit, a transmit bit, content bits, CRC (cyclic redundancy checking) bits, and an end bit, all totaling 48 bits for example.

Referring to FIG. 4a, the format for the command begins with the start bit that is set to a logical state of “0”. The transmit bit defines a transmission direction and is set to a logical state of “1” for indicating that the command is a signal that is transmitted from the host 502 to the memory card 504. In contrast, when the transmit bit is set to a logical state of “0”, a signal is a response that is transmitted from the memory card 504 to the host 502.

Further referring to FIG. 4a, the content bits include command bits and argument bits. For example, the command bits are comprised of six bits that may be decoded for indicating 64 types of commands. The argument bits specify information used for carrying out the command by the memory card 504. For example, the argument bits may be comprised of 32 bits for specifying an address for a write command. The command of FIG. 4a is protected by the cyclic redundancy checking (CRC) bits comprised of seven bits for example. Cyclic redundancy checking is individually and generally known to one of ordinary skill in the art. The end bit is set to a logical state of “1” and indicates the end of the command for terminating the command transmission.

Referring to FIG. 4b, the format for a response from the memory card 504 to the host 502 includes a start bit, a transmit bit, content bits, cyclic redundancy checking (CRC) bits, and an end bit. Referring to FIGS. 4a and 4b, the response format of FIG. 4b is similar to the command format of FIG. 4a.

The response format begins with the start bit set to a logic state of “0” that is followed by the transmit bit set to a logic state of “0”. The content bits include command bits and status bits. For example, the command bits are comprised of the 6 bits corresponding to the command as sent by the host 502 for which the response of FIG. 4b is being generated. The status bits are comprised of 32 bits for example including information regarding the current status of the memory card 504 in regard to the command corresponding to the command bits.

The memory card 504 is initialized in an identification mode. During such initialization, the host 502 acquires a variety of information regarding the memory card 504 such as capacity, manufacturer, and serial number of the memory card 504 for example.

During or after such initialization, the memory card system 500 performs a password confirmation. After such password confirmation, the memory card system 500 performs password transmission for maintaining the security of the memory card 504. For such security, the host 502 transmits a password to the memory card 504, and the memory card 504 performs a read or write operation when the password sent from the host 502 coincides with a password stored in the memory card 504.

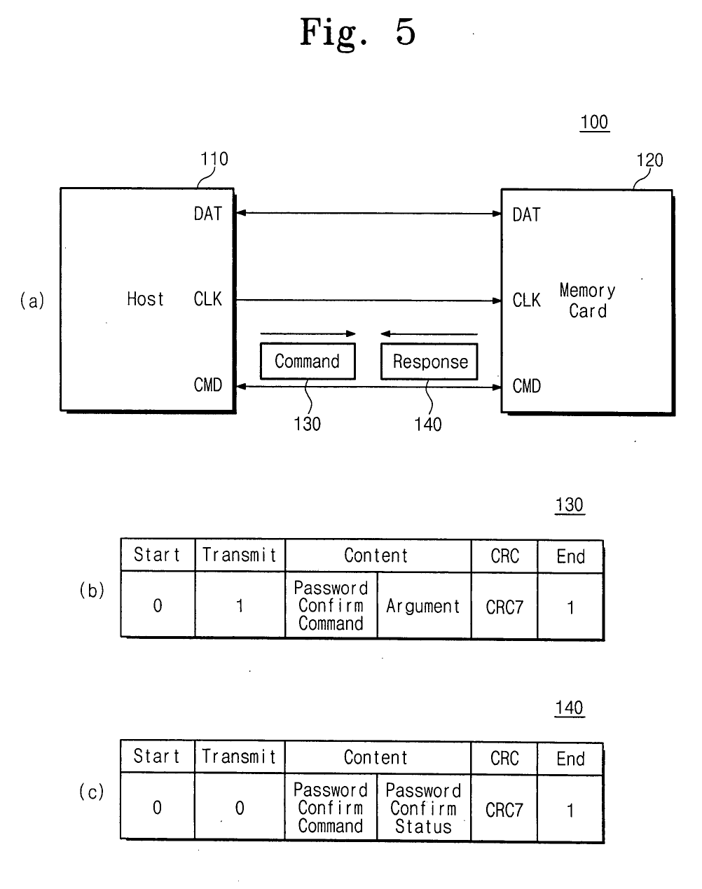

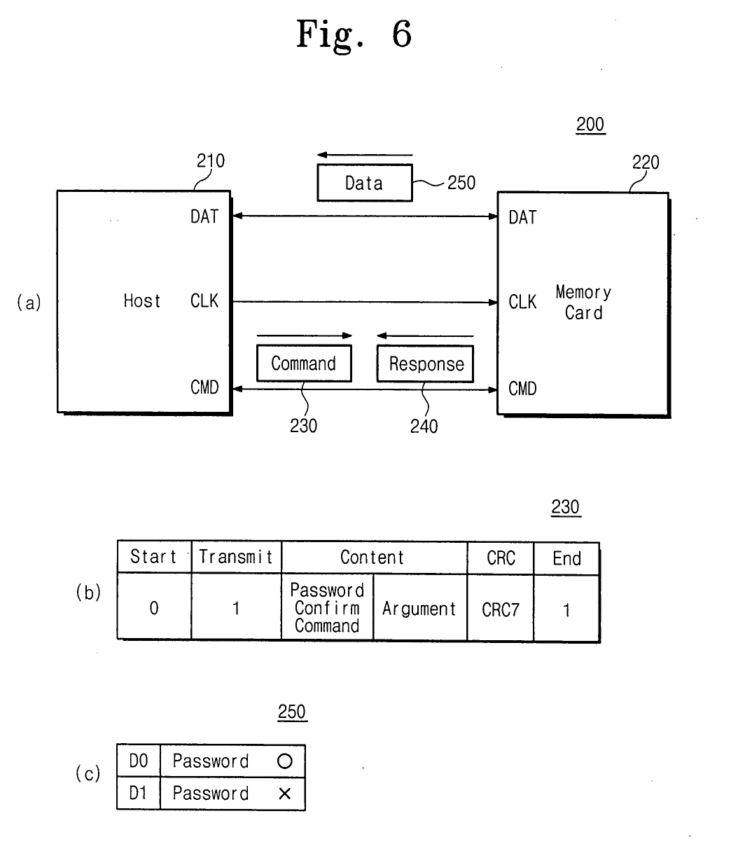

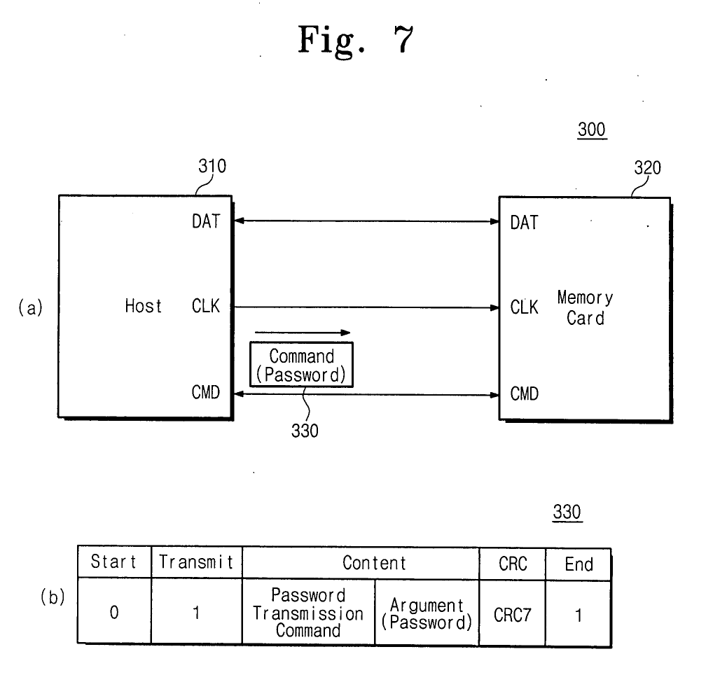

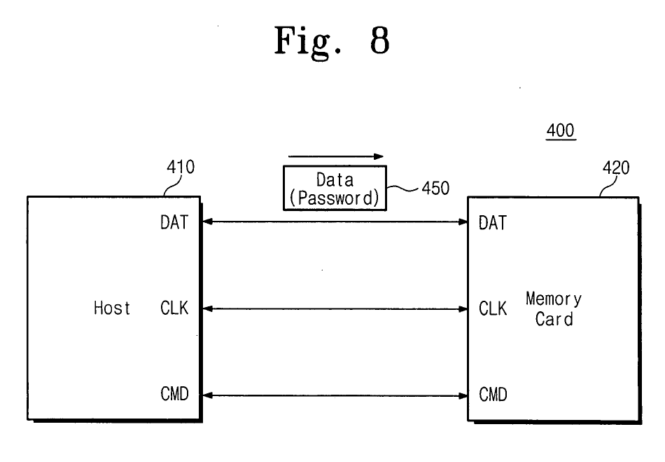

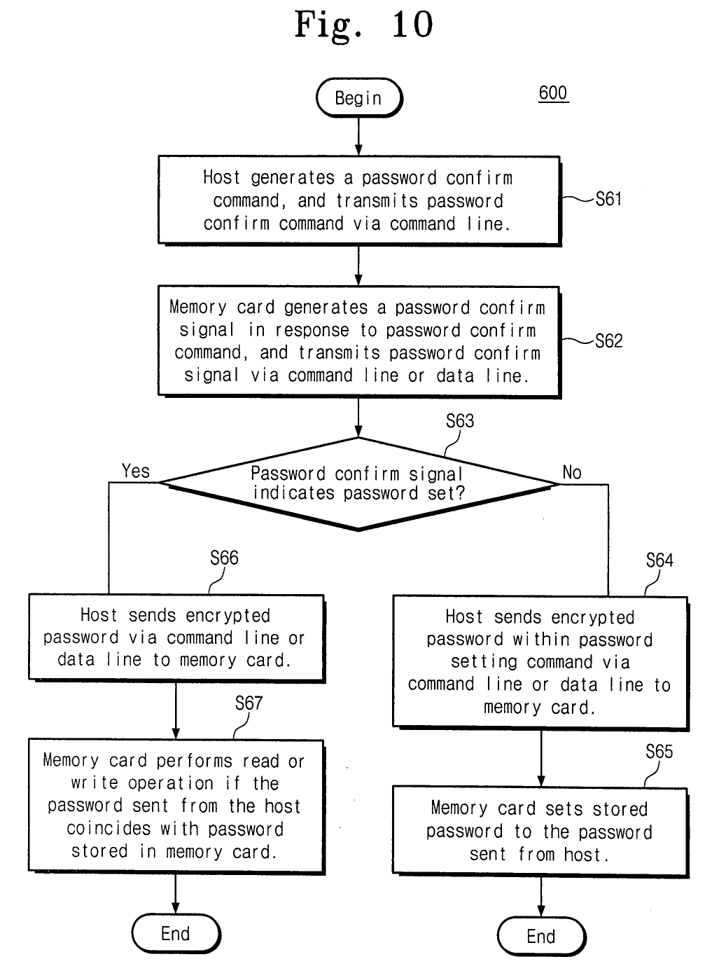

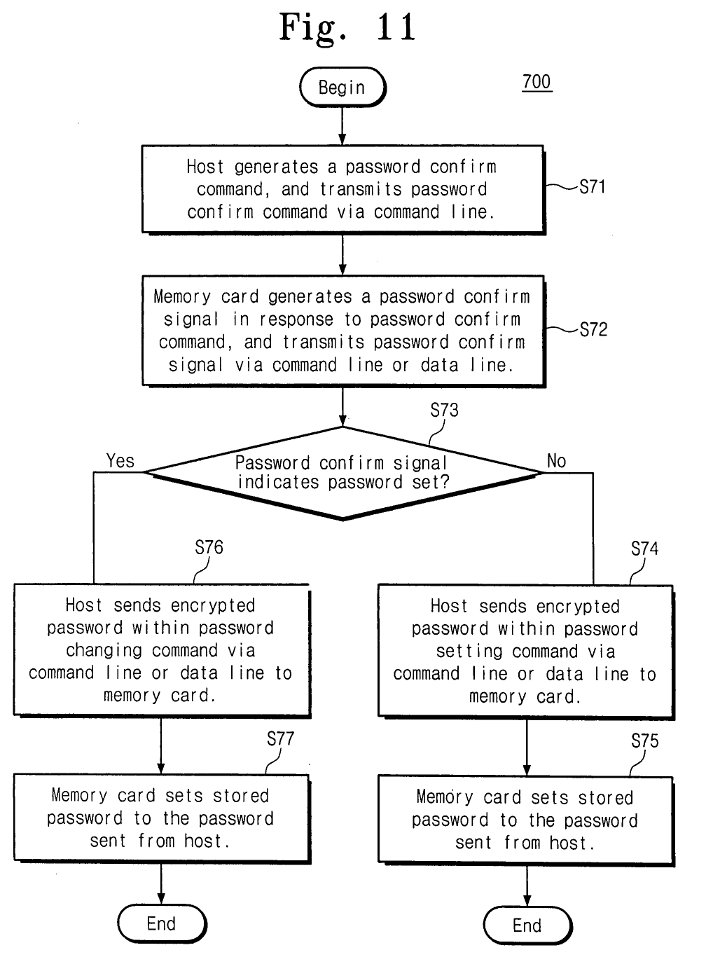

FIGS. 5a, 5b, 5c, 6a, 6b, and 6c illustrate password confirmation, and FIGS. 7a, 7b, and 8 illustrate password transmission. FIGS. 10 and 11 show flowcharts during operation of the memory card system of FIG. 5a, 6a, 7a, 8, or 9 according to an embodiment of the present invention.

Referring to FIGS. 9, 10, and 11, the host memory device 508 has sequences of instructions (i.e., software) stored therein. Execution of such sequences of instructions by the host data processor 506 causes the host data processor 506 to perform steps S61, S63, S64, and S66 of FIG. 10 and/or steps S71, S73, S74, and S76 of FIG. 11.

Further referring to FIGS. 9, 10, and 11, the card memory device 514 has sequences of instructions (i.e., software) stored therein. Execution of such sequences of instructions by the card data processor 512 causes the card data processor 512 to perform steps S62, S65, and S67 of FIG. 10 and/or steps S72, S75, and S77 of FIG. 11.

FIG. 5a shows a block diagram of a memory card system 100 performing password confirmation according to an embodiment of the present invention. Referring to FIG. 5a, the memory card system 100 includes a host 110 and a memory card 120. The host 110 and the memory card 120 of FIG. 5a are the host 502 and the memory card 504, respectively, of FIG. 9 according to one embodiment of the present invention. In that case, the host 110 and the memory card 120 are electrically connected to each other through the data line 518, the clock line 520, and the command line 522.

Referring to FIGS. 5, 9, 10, and 11, the host data processor 506 of the host 110 (502 in FIG. 9) generates a password confirm command 130 (step S61 in FIG. 10 and step S71 in FIG. 11) that is illustrated in FIG. 5b. The format of the password confirm command 130 of FIG. 5b is similar to the command format of FIG. 4a. According to an aspect of the present invention, a unique bit pattern of the command bits indicates a password confirm command.

The password confirm command 130 is for confirming if a password is set within the memory card 120. The prior art memory card system does not use such a password confirm command which is unlike the typical read or write command. The host data processor 506 of the host 110 (502 in FIG. 9) controls the host interface 510 to transmit the password confirm command 130 to the memory card 120 (504 in FIG. 9) via the command line 522 (step S61 in FIG. 10 and step S71 in FIG. 11).

The card data processor 512 of the memory card 120 (504 in FIG. 9) receives such a password confirm command 130 and generates a password command signal 140 of FIG. 5c in response to the password confirm command 130 (step S62 of FIG. 10 and step S72 of FIG. 11). The password command signal 140 of FIG. 5c has a format that is similar to the response format of FIG. 4b.

The password command signal 140 of FIG. 5c includes password confirm status bits that indicate whether a password is set within the memory card 120 (504 in FIG. 9). In one embodiment of the present invention, the respective command bits of the password confirm command 130 of FIG. 5b has a same bit pattern as the respective command bits of the password command signal 140 of FIG. 5c. The card data processor 512 of the memory card 120 (504 in FIG. 9) controls the card interface 516 to transmit the password confirm signal 140 to the host 110 (502 in FIG. 9) via the command line 522 (step S62 in FIG. 10 and step S72 in FIG. 11).

FIG. 6a shows a block diagram of a memory card system 200 performing password confirmation according to another embodiment of the present invention. Referring to FIG. 6a, the memory card system 200 includes a host 210 and a memory card 220. The host 210 and the memory card 220 of FIG. 6a are the host 502 and the memory card 504, respectively, of FIG. 9 according to one embodiment of the present invention. In that case, the host 210 and the memory card 220 are electrically connected to each other through the data line 518, the clock line 520, and the command line 522.

The host data processor 506 of the host 210 (502 in FIG. 9) generates a password confirm command 230 (step S61 in FIG. 10 and step S71 in FIG. 11) that is illustrated in FIG. 6b. Such a password confirm command 230 of FIG. 6b is similar to the password confirm command 130 of FIG. 5b. The host data processor 506 of the host 210 (502 in FIG. 9) controls the host interface 510 to transmit the password confirm command 230 to the memory card 220 (504 in FIG. 9) via the command line 522 (step S61 in FIG. 10 and step S71 in FIG. 11).

The card data processor 512 of the memory card 220 (504 in FIG. 9) receives such a password confirm command 230 and generates a password command signal 250 of FIG. 6c in response to the password confirm command 230 (step S62 of FIG. 10 and step S72 of FIG. 11). The card data processor 512 of the memory card 220 (504 in FIG. 9) controls the card interface 516 to transmit the password confirm signal 250 to the host 210 (502 in FIG. 9) via the data line 518 (step S62 in FIG. 10 and step S72 in FIG. 11).

FIG. 6c illustrates that a data “0” is transmitted on the data line 518 as the password confirm signal by the memory card 220 (504 in FIG. 9) when a password is set within the memory card 220 (504 in FIG. 9). Alternatively, FIG. 6c illustrates that a data “1” is transmitted on the data line 518 as the password confirm signal by the memory card 220 (504 in FIG. 9) when a password is not set within the memory card 220 (504 in FIG. 9).

In another embodiment of the present invention, the card data processor 512 of the memory card 220 (504 in FIG. 9) also generates a password confirm signal 240 in FIG. 6a similar to the password confirm signal 140 of FIG. 5c. Such password confirm signal 240 in FIG. 6a is transmitted via the command line 522.

In any case after the password confirmation of FIG. 5a or 6a, the memory card system 500 performs password transmission. FIG. 7a shows a block diagram of a memory card system 300 performing password transmission according to an embodiment of the present invention. Referring to FIG. 7a, the memory card system 300 includes a host 310 and a memory card 320. The host 310 and the memory card 320 of FIG. 7a are the host 502 and the memory card 504, respectively, of FIG. 9 according to one embodiment of the present invention. In that case, the host 310 and the memory card 320 are electrically connected to each other through the data line 518, the clock line 520, and the command line 522.

After the password confirmation of FIG. 5 or 6, the host 310 (502 in FIG. 9) determines from the password confirm signal 140, 240, or 250 whether a password has been set in the memory card 320 (504 in FIG. 9) (step S63 in FIG. 10 and step S73 in FIG. 11). FIG. 7b illustrates a format of a password transmission command 330. The format of the command in FIG. 7b is similar to the command format of FIG. 4a.

However, the command bits of the content bits has a unique bit pattern for indicating password transmission from the host 310 (504 in FIG. 9). In addition, the argument bits of the content bits includes an encrypted password being transmitted within the password transmission command 330.

If the password confirm signal 140, 240, or 250 indicates that a password has not yet been set in the memory card 320 (504 in FIG. 9) (step S63 in FIG. 10 and step S73 in FIG. 11), the host 310 (502 in FIG. 9) generates such a password transmission command 330 as a password setting command and controls the host interface 510 to transmit the password transmission command 330 to the memory card 320 (504 in FIG. 9) via the command line 522 (step S64 in FIG. 10 and step S74 in FIG. 11).

In that case, the command bits of the content bits has a unique bit pattern for indicating that the password sent from the host 310 (502 in FIG. 9) is to be stored within the memory card 320 (504 in FIG. 9). Upon receiving such a password setting command 330, the card data processor 512 of the memory card 320 (504 in FIG. 9) sets the stored password of the memory card 320 (504 in FIG. 9) to the password as contained within the password setting command 330 (step S65 in FIG. 10 and step S75 in FIG. 11).

FIG. 8 shows a block diagram of a memory card system 400 performing password transmission according to another embodiment of the present invention. Referring to FIG. 8, the memory card system 400 includes a host 410 and a memory card 420. The host 410 and the memory card 420 of FIG. 8 are the host 502 and the memory card 504, respectively, of FIG. 9 according to one embodiment of the present invention. In that case, the host 410 and the memory card 420 are electrically connected to each other through the data line 518, the clock line 520, and the command line 522.

The memory card system 400 of FIG. 8 operates similarly to the memory card system 300 of FIG. 7 to generate a password transmission command 330 that is a password setting command if the password confirm signal 140, 240, or 250 indicates that a password has not yet been set in the memory card 420 (504 in FIG. 9). However in FIG. 8, the host 410 (502 in FIG. 9) controls the host interface 510 to transmit the password transmission command 330 to the memory card 420 (504 in FIG. 9) via the data line 518 (step S64 in FIG. 10 and step S74 in FIG. 11).

Referring back to FIGS. 7a, 7b, and 10, if the password confirm signal 140, 240, or 250 indicates that a password has already been set in the memory card 320 (504 in FIG. 9) (step S63 in FIG. 10 and step S73 in FIG. 11), the host 310 (502 in FIG. 9) generates the password transmission command 330 having an encrypted password therein and controls the host interface 510 to transmit the password transmission command 330 to the memory card 320 (504 in FIG. 9) via the command line 522 (step S66 in FIG. 10 and step S76 in FIG. 11).

Alternatively in that case with the embodiment of FIG. 8, the host 410 (502 in FIG. 9) controls the host interface 510 to transmit the password transmission command 330 to the memory card 420 (504 in FIG. 9) via the data line 518 (step S66 in FIG. 10 and step S76 in FIG. 11). In any case of FIG. 7 or 8 with the embodiment of FIG. 10, the card data processor 512 of the memory card 320 or 420 (504 in FIG. 9) performs any subsequent read or write command if the password within such a password transmission command 330 sent from the host 310 or 410 (502 in FIG. 9) coincides with the password as stored in the memory card 320 or 420 (504 in FIG. 9) (step S67 in FIG. 10).

In any case of FIG. 7 or 8 with the embodiment of FIG. 11, the password transmission command 330 is generated as a password changing command. In that case, the command bits of the content bits has a unique bit pattern for indicating that the password sent from the host 310 or 410 (502 in FIG. 9) is to replace any other password stored within the memory card 320 or 420 (504 in FIG. 9). The host data processor 506 controls the host interface 510 to transmit such a password changing command 330 to the memory card 320 (504 in FIG. 9) via the command line 522 in FIG. 7a or via the data line 518 in FIG. 8 (step S76 in FIG. 11). In either case of FIG. 7a or 8, the card data processor 512 of the memory card 320 or 420 (504 in FIG. 9) sets the password as stored in the memory card 320 or 420 (504 in FIG. 9) to the password as contained within such a password changing command 330 (step S77 in FIG. 11).

In an alternative embodiment of the present invention, a marking 50 on the memory card 120 or 220 indicates whether a password has been set in the memory card 120 or 220 (504 in FIG. 9). A predetermined marking such as “P” indicates that a password has been set in the memory card 120 or 220 (504 in FIG. 9). With such a marking, a user already knows that a password is set in the memory card 120 or 220 (504 in FIG. 9). Thus, the password confirmation operation as illustrated in FIGS. 5 and 6 may not be performed in that case. Further in that case, the user via the host 110 or 210 (502 in FIG. 9) sends a password to the memory card 120 or 220 (504 in FIG. 9) for password transmission without password confirmation.

In this manner, new commands are used in the present invention for flexibility in password confirmation and password transmission within the memory card system. While the present invention has been particularly shown and described with reference to exemplary embodiments thereof, it will be understood by those of ordinary skill in the art that various changes in form and details may be made therein without departing from the spirit and scope of the present invention as defined by the following claims.

The present invention is limited only as defined in the following claims and equivalents thereof.

What is claimed is:

1. A memory card system comprising:
a host for generating a password confirm command; and
a memory card including a card data processor and a card memory device having first sequences of instructions stored thereon, wherein execution of the first sequences of instructions causes the card data processor to perform steps of:
generating a password confirm signal indicating whether a password is set in the memory card in response to the password confirm command; and
transmitting the password confirm signal to the host via at least one of a data line and a command line between the host and the memory card.

2. The memory card system of claim 1, wherein the host includes:
a host data processor; and
a host memory device having second sequences of instructions stored thereon, wherein execution of the second sequences of instructions causes the host data processor to perform a step of:
generating the password confirm command.

3. The memory card system of claim 2, wherein execution of the second sequences of instructions causes the host data processor to perform a step of:
transmitting the password confirm command from the host to the memory card via said command line.

4. The memory card system of claim 2, wherein execution of the second sequences of instructions causes the host data processor to perform steps of:
generating a password in response to the password confirm signal; and
transmitting the password to the memory card via at least one of said data line and said command line.

5. The memory card system of claim 4, wherein execution of the first sequences of instructions causes the card data processor to perform a step of:
performing an operation when the password from the host coincides with a password stored in the memory card.

6. The memory card system of claim 5, wherein execution of the first sequences of instructions causes the card data processor to perform a step of:
performing a read or write operation when the password from the host coincides with the password stored in the memory card.

7. The memory card system of claim 2, wherein execution of the second sequences of instructions causes the host data processor to perform steps of:
generating a password setting command in response to the password confirm signal;
generating a password within the password setting command; and
transmitting the password setting command from the host to the memory card via at least one of the command line and the data line.

8. The memory card system of claim 7, wherein execution of the first sequences of instructions causes the card data processor to perform a step of:
setting a password stored in the memory card to the password in the password setting command sent from the host.

9. The memory card system of claim 7, wherein the password within the password setting command from the host is encrypted.

10. The memory card system of claim 2, wherein execution of the second sequences of instructions causes the host data processor to perform steps of:
generating a password changing command in response to the password confirm signal;
generating a password within the password changing command; and
transmitting the password changing command from the host to the memory card via at least one of the command line and the data line.

11. The memory card system of claim 10, wherein execution of the first sequences of instructions causes the card data processor to perform a step of:
setting a password stored in the memory card to the password in the password changing command sent from the host.

12. The memory card system of claim 11, wherein the password within the password changing command from the host is encrypted.

13. The memory card system of claim 1, wherein the memory card is a secure digital (SD) card.

14. The memory card system of claim 1, wherein the memory card is a multi-media card (MMC).

15. The memory card system of claim 1, wherein a marking on the memory card indicates to a user whether a password is set in the memory card.

16. A memory card system comprising:
a host including:
means for generating a password confirm command; and
a memory card including:
means for generating a password confirm signal indicating whether a password is set in the memory card in response to the password confirm command; and
means for transmitting the password confirm signal to the host via at least one of a data line and a command line between the host and the memory card.

17. The memory card system of claim 16, further including:
means for transmitting the password confirm command from the host to the memory card via said command line.

18. The memory card system of claim 16, wherein the host further includes:
means for generating a password in response to the password confirm signal; and
means for transmitting the password to the memory card via at least one of said data line and said command line.

19. The memory card system of claim 18, wherein the memory card further includes:
means for performing a read or write operation when the password from the host coincides with a password stored in the memory card.

20. The memory card system of claim 18, wherein the memory card further includes:
means for setting a password stored in the memory card to the password sent from the host.
